(19) United States
(12) Patent Application Publication
(10) Pub. No.: US 2003/0007657 A1
(43) Pub. Date: Jan. 9, 2003

(54) Hearing aid with sudden sound alert

(75) Inventor: Carl Ludvigsen, Valby (DK)

Correspondence Address: SUGHRUE, MION, ZINN, MACPEAK & SEAS, PLLC, 2100 Pennsylvania Avenue, NW, Washington, DC, 20037-3213, US

(73) Assignee: TOPHOLM & WESTERMANN APS

(21) Appl. No.: 09/899,990

(22) Filed: Jul. 9, 2001

(51) Int. Cl. H04R 25/00

(52) U.S. Cl. 381/312; 381/320; 381/321

(57) ABSTRACT

A multichannel hearing aid is provided with at least one frequency channel having a compressor with a compression threshold with an output level below the hearing threshold and an attack time above 0.5 seconds whereby hearing of a sudden sound in a stationary sound environment is facilitated.

### FIELD OF THE INVENTION

The present invention relates to a hearing aid that alerts the user of occurrence of a sudden sound in a stationary sound environment.

### BACKGROUND OF THE INVENTION

Many hearing aid users being situated in a stable sound environment desire to be able to hear a sudden change in the sound environment, such as a sudden occurrence of a sound. For example, being at home, a hearing aid user may desire to be able to hear that a baby starts crying, or that water starts running, that somebody is present at the door, etc. The hearing aid user can increase the gain of the hearing aid to accomplish this but then the hearing aid user may be bothered by other sounds in the stationary sound environment such as the sound of a ventilator, traffic noise, etc, that are now amplified above the hearing threshold. The hearing threshold is the lowest sound level at which sound is perceived.

### SUMMARY OF THE INVENTION

It is an object of the present invention to provide a hearing aid that makes it possible for the user to hear a sudden sound occurring in a stationary sound environment without being bothered with stationary sounds.

It is well known in the art to provide a hearing aid having a compressor with a characteristic that has two linear segments that are interconnected at a knee-point typically at 50 dB SPL input level. Below the knee point, the linear segment has substantially no compression, i.e. the gain is a constant gain compensating for the hearing loss at low input signal levels. Above the knee point, the segment has a compression ratio above 1, typically 2:1, for compensating for recruitment. Recruitment is a sensorineural hearing loss whereby loudness increases rapidly with increased sound pressure just above the hearing threshold and increases normally at high sound pressures.

According to the present invention, the above-mentioned and other objects are fulfilled by provision of a multichannel hearing aid having a compressor with a compression threshold with an output level below the hearing threshold. The amplification of low signal levels is hereby increased compared to the prior art. In the hearing aid according to the present invention, the microphone noise is so low that the amplified microphone noise is still below the hearing threshold although the gain has been increased compared to the prior art.

The compressor is provided with a slow attack time, such as an attack time above 0.5 seconds, preferably above 1 seconds, for example 2 seconds or more.

It is an important advantage of the present invention that the gain of the hearing aid is large at low original levels while the microphone noise is still kept just below the hearing threshold. When a sudden sound occurs, the sound is amplified with the current large gain above the hearing threshold so that it can be heard by the hearing aid user. If the sudden sound persists for a longer time than the attack time of the compressor, the gain will decrease with time and eventually the sudden sound will no longer be amplified above the hearing threshold. Thus the sudden sound can be heard by the hearing aid user for substantially the attack time of the compressor which is a sufficient period for the user to be alerted by the sound.

Still other objects of the present invention will become apparent to those skilled in the art from the following description wherein the invention will be explained in greater detail. By way of example, there is shown and described a preferred embodiment of this invention. As will be realized, the invention is capable of other different embodiments, and its several details are capable of modification in various, obvious aspects all without departing from the invention. Accordingly, the drawings and descriptions will be regarded as illustrative in nature and not as restrictive. In the drawing:

### BRIEF DESCRIPTION OF THE DRAWING

FIG. 1 shows a prior art compressor characteristic,

FIG. 2 shows a compressor characteristic according to the present invention,

FIG. 3 illustrates amplification by a hearing aid according to the present invention of a sudden sound in a stationary sound environment, and

FIG. 4 shows a blocked diagram of a hearing aid according to the present invention.

### DETAILED DESCRIPTION OF PREFERRED EMBODIMENTS

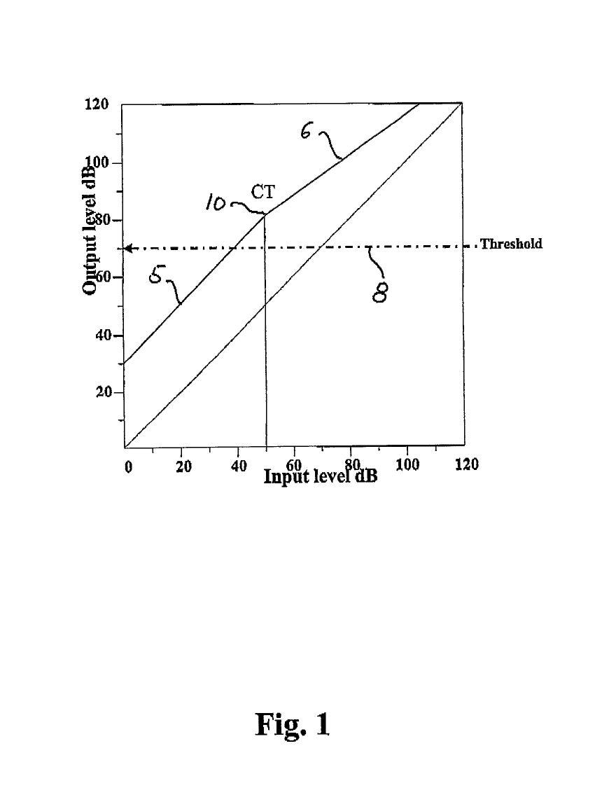

FIG. 1 shows a plot of a prior art compressor characteristic, i.e. a plot of the compressor output level as a function of the input level both in SPL. The characteristic comprises two linear segments 5, 6, that are interconnected at a knee-point 10 (CT—Compression Threshold) typically positioned at 50 dB SPL input level. Below the knee point 10, the linear segment 7 has substantially no compression, i.e. the gain is a constant gain compensating for the hearing loss at low input signal levels. Above the knee point 10, the segment 6 has a compression ratio above 1, typically 2:1, for compensating for recruitment. The compression ratio of a segment is equal to the reciprocal value of the slope of the segment.

In order to be able to hear a sudden change in the sound environment, such as a sudden occurrence of a sound, the hearing aid user can increase the gain of the hearing aid thereby displacing the characteristic shown in FIG. 1 upwardly in the direction of the y-axis. Then, however, other sounds in the stationary sound environment, such as the sound of a ventilator, traffic noise, etc. will be amplified above the hearing threshold causing an uncomfortable disturbance of the user.

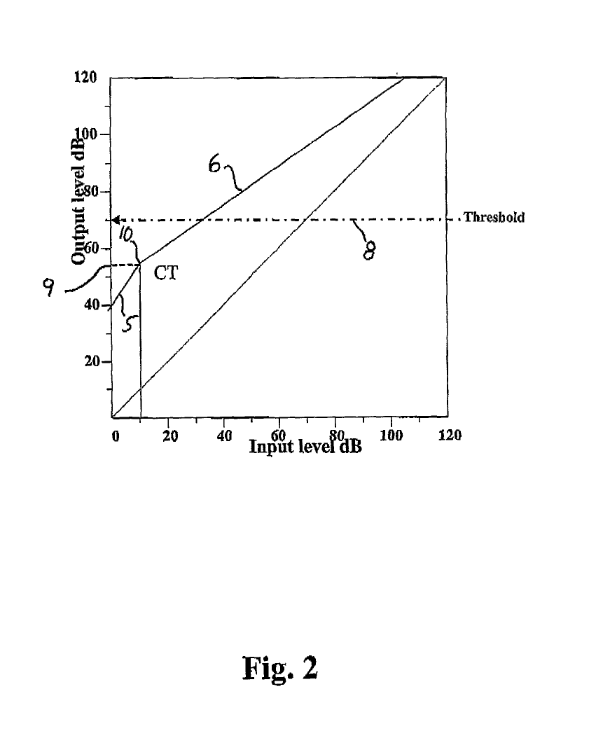

FIG. 2 shows a compressor characteristic of a compressor according to the present invention. In FIG. 2, the segments 5, 6 correspond to the segments 5, 6 shown in FIG. 1. Preferably, segment 6 has a compression ratio that is greater than 1.4, and more preferred that is substantially equal to 2. Other values of the compression ratio may be used if appropriate. It is the gist of the present invention that the output level 9 of the knee-point or compression threshold is lower than the hearing threshold 8. Therefore the gain is larger at low signal levels than for the prior art compressor. The hearing aid according to the present invention may have a microphone that generates little microphone noise and/or may have a plurality of channels, preferably more than 6 channels, more preferred more than 8 channels, most preferred more than 10 channels, e.g. 15 channels. Since noise in each channel is substantially proportional to channel bandwidth, an increase in number of channels leads to a reduction of the noise in each channel. Thus, in spite of the increased gain, the noise in a channel is still maintained below the hearing threshold. In the present example, the knee point is situated at 10 dB SPL input level. Typically, the knee-level is situated below 25 dB SPL input level, more often below 20 dB SPL input level, for example below 15 dB SPL.

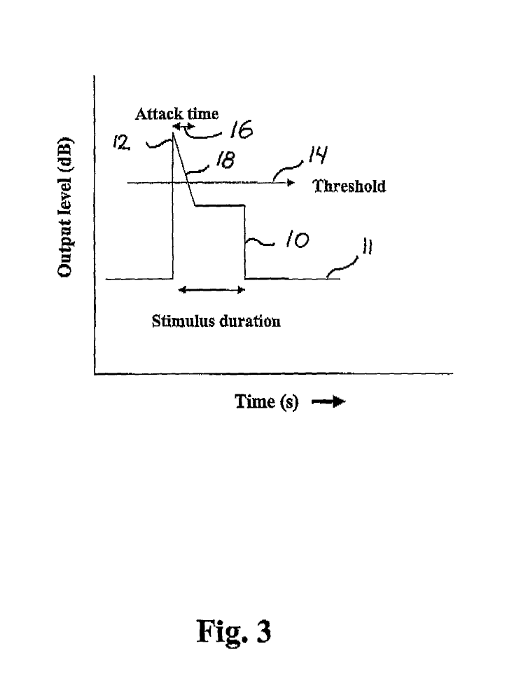

FIG. 3 illustrates amplification by a hearing aid according to the present invention of a sudden sound 10 in a stationary sound environment 11. The compressor is provided with a slow attack time, such as 1 or 2 seconds. When a sudden sound 10 occurs, the sound is amplified 12 with the current large gain above the hearing threshold 14 so that it can be heard by the hearing aid user. If the sudden sound persists for a longer time than the attack time 16 of the compressor, the gain will decrease with time 18 and eventually the sudden sound will no longer be amplified above the hearing threshold 14. Thus the sudden sound 10 can be heard by the hearing aid user for substantially the attack time 16 of the compressor which is a sufficient period for the user to be alerted by the sound.

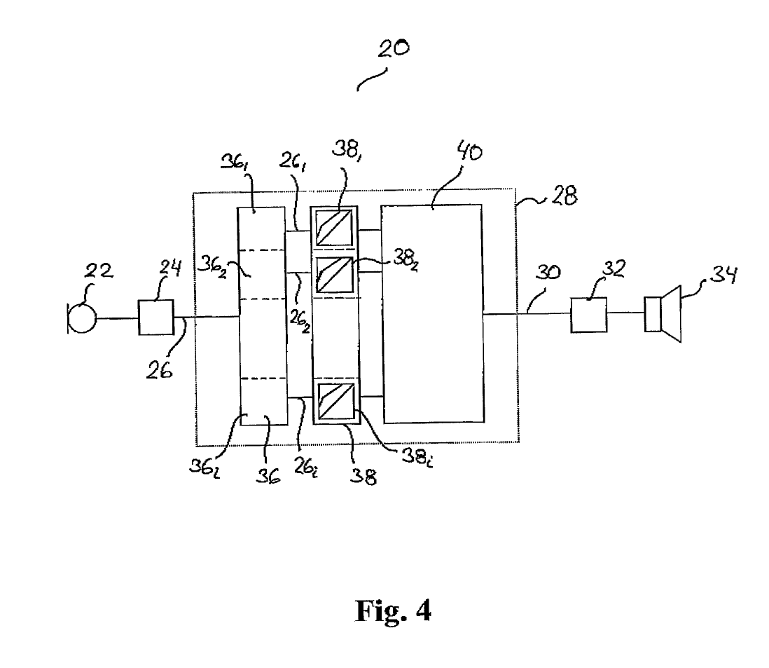

FIG. 4 shows a schematic block diagram of a hearing aid 20 according to the present invention. It will be obvious for the person skilled in the art that the circuits indicated in FIG. 6 may be realized using digital or analogue circuitry or any combination hereof. In the present embodiment, digital signal processing is employed and thus, the processor 28 consists of digital signal processing circuits. In the present embodiment all the digital circuitry of the hearing aid 20 may be provided on a single digital signal processing chip or, the circuitry may be distributed on a plurality of integrated circuit chips in any appropriate way.

In the hearing aid 20, a microphone 22 is provided for reception of a sound signal and conversion of the sound signal into a corresponding electrical signal representing the received sound signal. The hearing aid 20 may comprise a plurality of input transducers 22, e.g. whereby desired direction sensitive characteristics may be provided. The microphone 22 converts the sound signal to an analogue signal. The analogue signal is sampled and digitized by an A/D converter 24 into a digital signal 26 for digital signal processing in the hearing aid 20. The digital signal 26 is fed to a digital signal processor 28 for amplification of the microphone output signal 26 according to a desired frequency characteristic and compressor function to provide an output signal 30 suitable for compensating the hearing deficiency of the user. The output signal 30 is fed to a D/A converter 32 and further to an output transducer 34, i.e. a receiver 34, that converts the output signal 30 to an acoustic output signal.

The signal processor 28 comprises a first filter bank 36 with bandpass filters 36ᵢ for dividing the electrical signal 26 into a set of bandpass filtered first electrical signals 26₁, 26₂, . . . , 26ᵢ. Further, the signal processor 28 comprises a set 38 of compressors and offset amplifiers 38₁, 38₂, . . . , 38ᵢ each of which is connected to a different bandpass filter 36₁, 36₂, . . . , 36ᵢ for individual compression of the corresponding bandpass filtered signal 26₁, 26₂, . . . , 26ᵢ the compressor and offset amplifiers 38₁ and 38₂ in the low frequency bands 36₁ and 36₂ having compressor characteristics in accordance with the present invention.

The illustrated compressor characteristics 38₁ and 38₂ correspond to the characteristic shown in FIG. 2. In the present example, 36₁ and 36₂ are low frequency bandpass filters, e.g. with passbands below 500 Hz. 36₁ may have a passband below 300 Hz and 36₂ may have a passband between 300 Hz and 500 Hz. For simplicity, compressors are not illustrated in every frequency band. Compressors with characteristics in accordance with the present invention may be included in any appropriate frequency channel.

1. A multichannel hearing aid with at least one frequency channel having a compressor with a compression threshold with an output level below the hearing threshold and an attack time above 0.5 seconds, whereby hearing of a sudden sound in a stationary sound environment is facilitated.
